(19) United States
(12) Patent Application Publication
(10) Pub. No.: US 2024/0148479 A1
(43) Pub. Date: May 9, 2024

(54) CONTROLLED LOCAL MODIFICATION OF VOLUMETRIC PHYSICAL PROPERTIES

(71) Applicant: DENTSPLY SIRONA Inc., York, PA (US)

(72) Inventor: Sascha Schneider, Mühltal (DE)

(73) Assignee: DENTSPLY SIRONA Inc., York, PA (US)

(21) Appl. No.: 17/980,582

(22) Filed: Nov. 4, 2022

(51) Int. Cl. A61C 13/00; B33Y 10/00; B33Y 50/00

(52) U.S. Cl. CPC A61C 13/0004; B33Y 10/00; B33Y 50/00

(57) ABSTRACT

Manufacturing a dental part with volumetric units that vary in translucency, shading and/or color. A beam translation module of a 3D printing system is used to translate an input pattern into an output for controlling a spatial structuring of light for 3D printing an object from a resin material that is sensitive to light intensity, light color or light exposure time.

### TECHNICAL FIELD

The present invention relates generally to 3D (three-dimensional) printing. More specifically, the present invention related to providing a way to manufacture a dental part that varies locally in translucency, shading and/or color.

### BACKGROUND

A 3D printing apparatus may be used for the manufacturing of a 3D object such as 3D dental object with a desired shape through exposing a photocurable substance with images that may transform monomers and oligomers of the photocurable substance into polymers. Those polymers may then make up the body of a 3D (three-dimensional) solid.

### SUMMARY

In an aspect, a 3D printing method is disclosed. The method may include providing at least one light source; computing, by a beam translation module, a property pattern for a layer of a virtual 3D model, the property pattern including at least a first light property configured to produce a desired physical characteristic of a first volumetric unit of a physical 3D object being printed; structuring an illumination beam of the at least one light source based on the computed property pattern; and projecting the structured illumination beam onto a material to produce the physical 3D object having said desired physical property. The material may be a photosensitive resin or a photosensitive extruded material, and the first volumetric unit may be applicable to all portions of the layer being 3D printed as opposed to edges thereof.

The method may also include configuring the property pattern as a pixel pattern and where the pixel pattern includes at least a first 2D pixel configured to represent the first light property. The property pattern may be a light color pattern, a light intensity pattern or a light exposure length per pixel pattern. These may be formatted as a number pattern, a letter pattern, a keywords pattern and/or a coordinates pattern.

Further, the physical property may be a property selected from the list consisting of a color of at least a portion the physical 3D object, a translucency of at least a portion of the physical 3D object and shading of at least a portion of the physical 3D object.

In one aspect, a system may be disclosed. The system may include at least one light source, a beam translation module, and a processor configured to compute, by the beam translation module, a property pattern for a layer of a virtual 3D model. The property pattern may include at least a first light property configured to produce a desired physical characteristic of a first volumetric unit of a physical 3D object being printed. The system may spatially structure an illumination beam of the light source based on the computed property pattern and project the structured illumination beam onto a material that is photosensitive to the beam to produce the physical 3D object having said desired physical property.

In yet another aspect, a non-transitory computer-readable storage medium may be disclosed which may store a program which, when executed by a computer system, causes the computer system to perform a procedure includes the steps of computing, by a beam translation module, a property pattern for a layer of a virtual 3D model, the property pattern including at least a first light property configured to produce a desired physical characteristics/property of a first volumetric unit of a physical 3D object being printed; structuring an illumination beam of a light source based on the computed property pattern; and projecting the structured illumination beam onto a material to produce the physical 3D object having said desired physical property. Other technical features may be readily apparent to one skilled in the art from the following figures, descriptions, and claims.

### BRIEF DESCRIPTION OF THE DRAWINGS

To easily identify the discussion of any particular element or act, the most significant digit or digits in a reference number refer to the figure number in which that element is first introduced.

FIG. 1 depicts a block diagram of a 3D printing system in accordance with one or more illustrative embodiments.

FIG. 2 depicts a block diagram of a 3D printing system in accordance with one or more illustrative embodiments.

FIG. 3 depicts a block diagram of a 3D printing system in accordance with one or more illustrative embodiments.

FIG. 4 depicts a process in accordance with one or more illustrative embodiments.

FIG. 5 depicts a computer system in accordance with one or more illustrative embodiments.

FIG. 6 depicts a perspective view of a virtual 3D model of a tooth in accordance with one or more illustrative embodiments.

### DETAILED DESCRIPTION

The illustrative embodiments recognize that a user such as dental practitioner may use a 3D printing system to print an object. The object may be printed with an additive manufacturing process which may include techniques such as fused deposition modelling (FDM), selective laser sintering (SLS), and stereolithography (SL).

In a 3D printing process, a setup may be constructed comprising a light source, wherein the light source may project irradiation masks for a curing reaction and may provide an unstructured light field causing an inhibition reaction.

The illustrative embodiments are directed to manufacturing a dental part that varies locally in translucency, shading and/or color wherein the dental part may be produced by 3D printing. The term “local” is generally used herein to refer to a unit volume or area of a dental part. For example, the dental part varying locally may refer to the dental part having a first unit volume that may possess a translucency, shading and/or color value that is different from the translucency, shading and/or color value of an adjacent second unit volume. The difference may be due to differences in light directed to said first and second unit volumes.

The illustrative embodiments recognize that a manual process may be performed to create an individualized, shaded, esthetic restoration wherein different colored ceramics/resins may be stacked, or an outer surface of the restoration may be painted with one or more colors. The illustrative embodiments recognize that these are largely manual and ineffective and may not allow precise control of the characteristics of individual unit volumes of a printed object.

In an aspect, a method and a system are disclosed. The method and system may vary, during a printing process, selected properties of light such as color/intensity and/or exposure length per unit volume or unit area of a 3D object to be printed. For example, during an SLA (Stereolithography) printing process, a structured beam may be generated by a light engine based on a “2D pixel input to 3D voxel output” process. The 2D pixel may be representative of, for example, properties of a portion of a “slice” or a portion of a virtual layer of a virtual 3D image of the object to be printed and the 3D voxel may be representative of a unit volume of the object to be printed corresponding to said 2D pixel. The 2D pixel input may thus be used to define the characteristics of light needed to achieve defined properties of the corresponding unit volume/3D voxel of the object to be printed. Based on the defined characteristics of light for one or more 2D pixels, a spatially structured illumination beam may be generated and projected at the same time or in succession for the one or more unit volumes/3D voxels corresponding to the one or more pixels. Of course, the input may not be limited to 2D pixel values as other forms or patterns for representing desired characteristics of unit volumes of 3D objects or for representing the properties of light usable to achieve said desired characteristics of unit volumes of the 3D object to be printed, such as number patterns, letter patterns, keywords and/or coordinates, etc. (which are herein collectively referred to generally as “property patterns”) may be used.

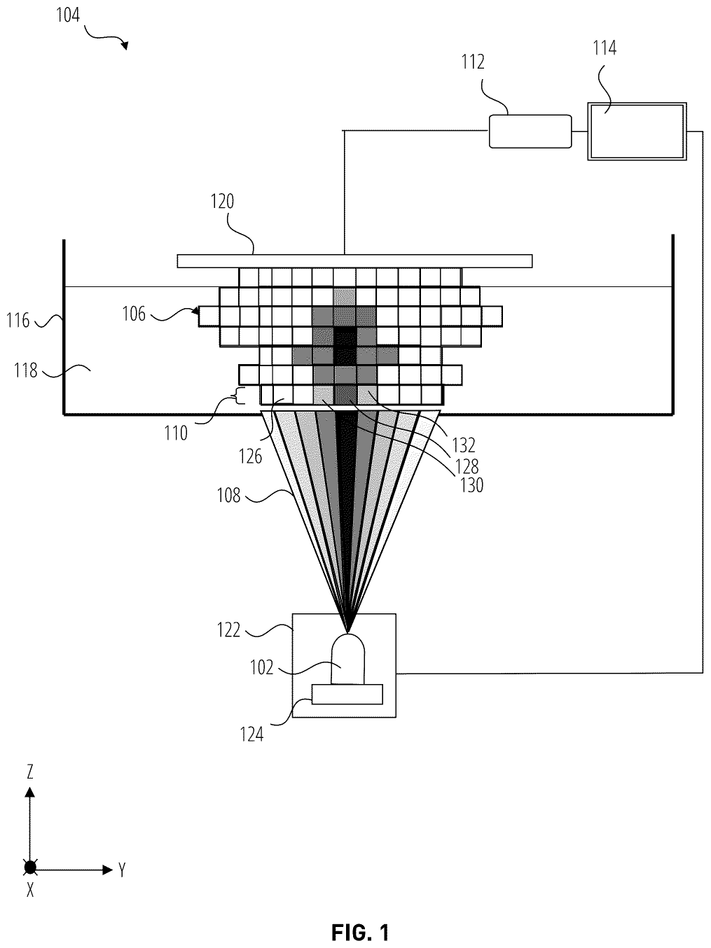

Turning to FIG. 1, a 3D printing system 104 is shown. The 3D printing system 104 may comprise a light source 102, a driving unit 112, a control unit 114, a vat 116, a material 118 for producing the physical 3D object and a platform 120. The control unit 114 may comprise one or more processors that may be configured to control operation of the 3D printing system 104. In one aspect, at least one light source 102 is provided. The light source 102 may be part of a light engine 122 which may comprise a beam translation module 124. The beam translation module 124 may be any device or computer or processor configured to compute a pixel pattern/property pattern for each layer of the virtual 3D model, the pixel pattern including at least a first 2D pixel/or property representative of a structured of light or that may provide information about a desired property of light for illuminating a corresponding volumetric unit 126 in the material 118 to form a portion of the physical 3D object 106 being printed. Thus, there may be a spatial relationship between adjacent volumetric units 126 that may be determined by the arrangement of corresponding 2D pixels of the pixel pattern. The pixel pattern/property pattern may also optionally include information about a height of the layer 110 being printed. In an example, the pixel pattern/property pattern may indicate that a volumetric unit A 128 located in a mid-portion of the layer 110 currently being 3D printed may receive, from a portion of the structured illumination beam 108, light of higher intensity/different color/higher exposure time than the intensity/color/exposure time of light received by adjacent volumetric units 126 in the X or Y direction (e.g. volumetric unit B 130 and volumetric unit C 132). This may be achieved by configuring the light engine 122 to alter the intensity/color/exposure length of portions of the light from the light source, based on the pixel pattern/property pattern, prior to reaching the material 118. Thus, the extent of alteration of the light property may be based on the value of the corresponding 2D pixel or property as dictated by the pixel pattern/property pattern. The local translucency, shading and/or color of a 3D printed part may therefore be set by the local exposure light color, intensity or exposure time during printing resulting in embedding that setting/feature during the stacking/layering of the individual slices/stacks and individual volumetric units of the 3D print while it is being built up. The 3D printing system 104 may thus control this per pixel→voxel relationship by the light engine 122 with the beam translation module 124.

In an aspect herein, the material may be disposed in the vat 116 and may be a photosensitive resin. Alternatively, the material may be a photosensitive extruded material having individual volumetric units that may be individually illuminated in a modified FDM (fused deposition modeling) process by application of structured light to the extruded material. Further, the volumetric units 126 that are individually printed may not be confined to just edges of the layer 110 currently being 3D printed, i.e., the 3D Printing system 104 may not be limited to just using different pixel intensities to generate an anti-aliasing effects to soften out the artefact lines on the object surface between the different Z layers but may be configured to apply different structures of light to individual volumetric units in the X-Y plane to generate different local shade/translucency of the internal and external portions the 3D object. A driving unit 112 may be configured to move the platform 120 and thus the physical 3D object 106 in a defined direction during the 3D printing process.

In an aspect herein, the material 118 may be a resin that, while not yet being finally cured, may be reactive to light exposure time, light intensity and/or different light colors, i.e., different electromagnetic wavelengths applied to individual volumetric units 126. Some resins/photosensitive materials may be reactive to different external influencing factors including external chemical influences, and some other resins may be reactive to other external influencing factors including UV light and exposure light intensity. The illustrative embodiments recognize that the time period in which a resin is exposed to UV light and/or the intensity of light exposure to the resin may have an effect on the color of the resin. For example, the curing time of 3D-printed resins in a curing process using UV light may affect the color stability and related properties such as degree of conversion (DC), surface roughness after aging water sorption, and water solubility. The longer the curing time of the tooth-colored 3D-printed resin, the better the color stability. Thus, some resins may respond to different types of light exposed thereto at defined time periods and under defined conditions of the resin. In another example, a resin or photosensitive material may be responsive to light exposure only after being activated by an activating chemical. For example, a 3D Printing system may control the structure of light projected, by configuring a light engine to confine photochemical activation and inhibition reactions of a polymerization process of a photosensitive resin not only to a region of the photosensitive resin corresponding to a cross section of an object being printed, but also to individual volumetric units as described herein. Thus, any material or resin that while not fully cured is able to react to light exposure time, light intensity, light color and/or other primary properties of light such as propagation direction, frequency and polarization may be used herein. Even more specifically, any resin/material that may be manipulated (i) by light during printing and stabilized afterwards, e.g., by curing using a different wavelength spectrum than the wavelength spectrum used during the printing or (ii) by applying predetermined chemicals or predetermined temperatures or other applicants to it, or (iii) by activating the resin's ability to react to light exposure for printing and deactivating the exposure sensitivity, may be used. Particularly, an ability to precisely control the color, translucency and/or shading per unit area/unit volume or voxel of the object being printed without necessarily affecting adjacent areas/voxels may be desirable.

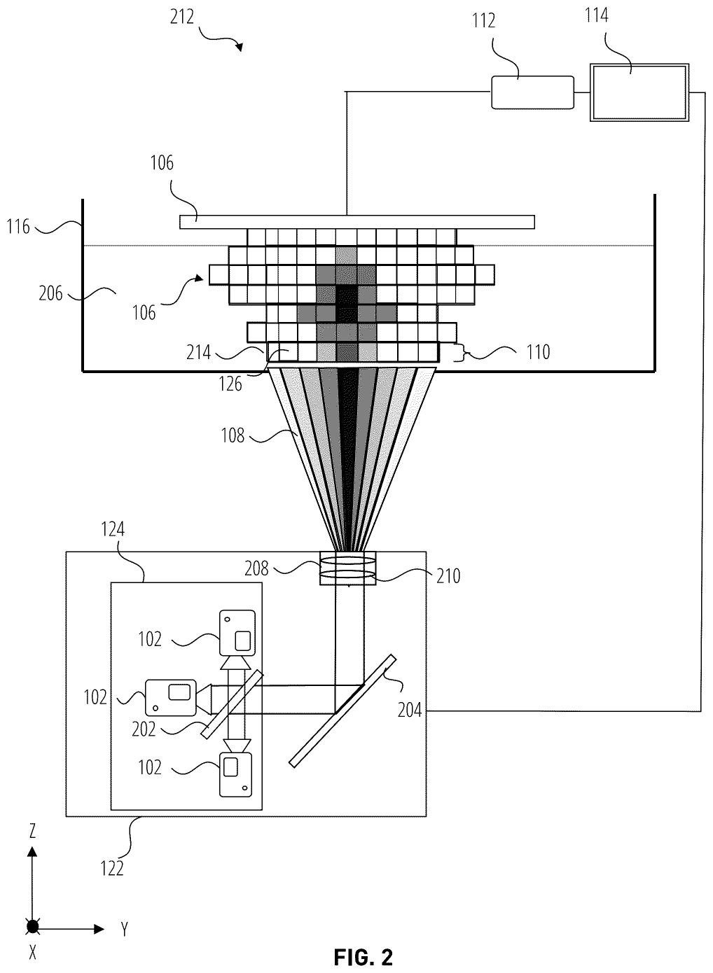

Turning now to FIG. 2, another 3D printing system is shown. The 3D printing system 212 may comprise a light source 102, a structured illumination beam 108, a driving unit 112, a control unit 114, a vat 116, a dichroic mirror 202, a digital micromirror device 204, a photosensitive material 206, an optical system 208, and a lens 210.

The light source 102 may be a plurality of light sources 102. The 3D printing system 212 may be a stereolithography-type apparatus. Pixel-based systems that create digital masks, or laser beams in conjunction with controllable micromirrors may be used to project layered images, particularly pixel-based layered images, into a reference surface in the photosensitive material 206 to harden it stepwise or continuously. By using the light engine 122 with the beam translation module 124 to compute a series of pixel patterns, said patterns may be used to project light onto the photosensitive material 206 to print the 3D object layer by layer while ensuring each unit volume obtains a predefined form. The projection may be performed with a pattern projector that may alter discrete portions of light based on an input. An example pattern projector may be a digital micromirror device 204 (DMD). Several hundred thousand microscopic mirrors that may be arranged in a rectangular pattern on the surface of a DMD chip may correspond to the pixels in the pixel pattern. Each mirror may be turned separately by, for example, 10 to 12 degrees for a on or off state. When the projector is turned on, light from the source may be reflected into a lens, making the volumetric unit 126 to be illuminated. The volumetric unit 126 appears unaffected in the off state because the light is being focused elsewhere (e.g., onto a heatsink). The mirror may also be swiftly turned on and off to create different intensities or colors or exposure times. In an example, the ratio of on time to off time may defines the shade or translucency of the volumetric unit 126. Of course, other pattern projectors configured to alter other properties of light, based on an input pattern, for projecting discrete portions of light onto the photosensitive material 206 may be used. The extent of alteration of the light property may be based on the value of the corresponding 2D pixel or property as dictated by the pixel pattern/property pattern. The local translucency, shading and/or color of a 3D printed part may therefore be set by the local exposure light color, intensity or exposure time during printing resulting in embedding that setting/feature during the stacking/layering of the individual slices/stacks and individual volumetric units of the 3D print while it is being built up. This may not be confined to just outer pixels or edges 214 of the layer 110 currently being 3D printed but may rather be applicable to all volumetric units 126 in the X-Y plane, with the photosensitive material 206 being a resin that while not yet fully cured is responsive to light exposure time, light intensity, light color and/or other primary properties of light to effect a corresponding translucency, shading and/or color of the volumetric units 126.

The layer 110 that is currently being printed may be defined through the focal layer in which the curing of the photosensitive material 206 occurs. Depending on the application, the layer 110 may have a rigid or flexible consistency and may generally be located on the bottom of the vat. During the exposure, the layer 110 may be prevented from sticking to the bottom of the vat 116 through photoinhibition. After the exposure, the platform may be moved up via the driving unit 112 controlled by a control unit 114 to give way for more photosensitive material 206 to be photocured. The inflowing photocurable substance may be cured by the subsequent exposure. These steps may be repeated until the physical 3D object 106 has been generated in accordance with the desired translucency, shading and/or color as defined by the input pattern.

In an illustrative embodiment of the 3D printing system 212, the light sources 102 may be configured to emit light having different specifications. For example, a first light source may emit a first light beam having a first wavelength. A second light source may be configured to emit a second light beam having a second wavelength different from the first wavelength and so on. A dichroic mirror 202 may be disposed in an optical path of the 3D printing system 212 and configured to superimpose the beams. In another example, the light sources 102 may emit light beams having different intensities, light color and/or other primary properties of light. In a further example, a first light beam may initiate photopolymerization or photoinhibition and another light beam may initiate the translucency, shading and/or color changes of the volumetric units 126. The pattern projector may then selectively project combinations of the light beams to the layer 110 for 3D printing. The 3D printing system 212 may further configure the pattern projector or DMD and the optical system 208 to confine photochemical activation and inhibition reactions of the photosensitive resin to a region of the photosensitive resin corresponding to a cross section of an object being printed.

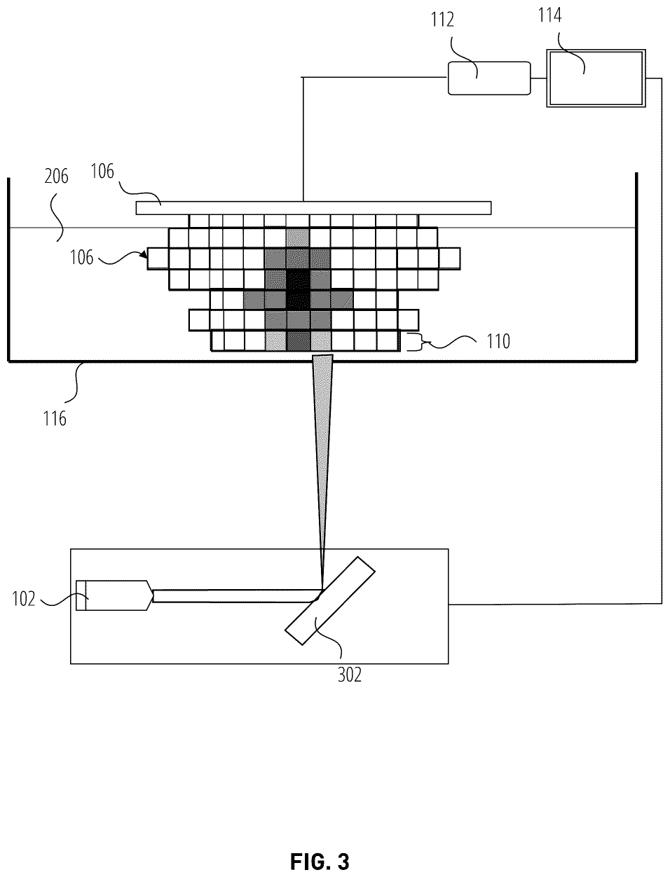

In an illustrative embodiment, as shown in FIG. 3, an x-y scanning mirror 302 may be used wherein the beam from the light source 102 falls on the X-Y Scanning mirror which points the beam onto the photosensitive material 206 and traces the geometry of the design. Based on the property/pixel pattern, the light source 102 may be operated to deliver different configurations of light to different parts of the layer 110 to 3D print the physical 3D object 106.

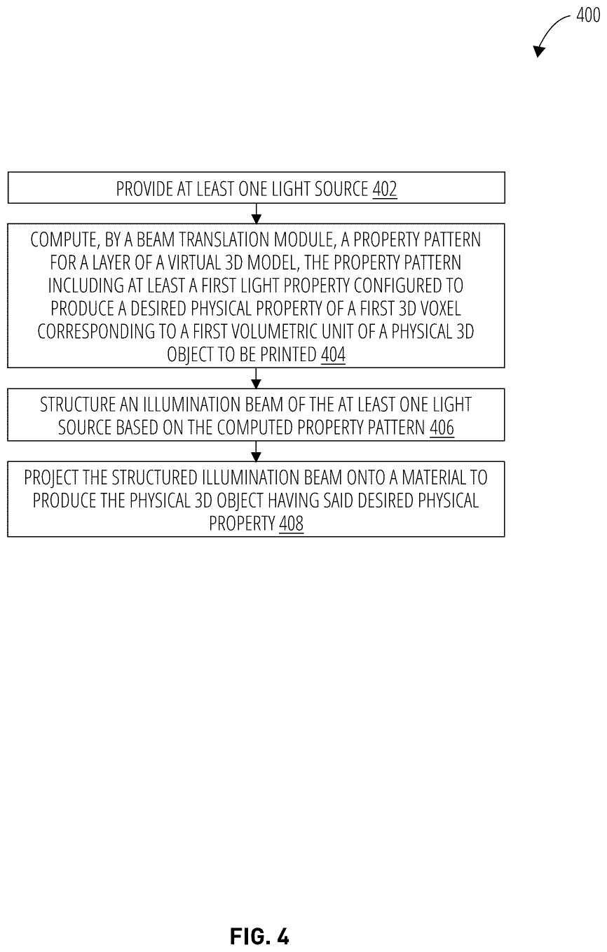

Turning now to FIG. 4, a process 400 of 3D printing by controlled local modification of volumetric physical properties is shown. The process 400 may begin at step 402 wherein at least one light source may be provided. In step 404, process 400 may compute, by a beam translation module, a property pattern for a layer of a virtual 3D model corresponding to the physical 3D object 106 to be printed, the property pattern including at least a first light property configured to produce a desired physical property of a first volumetric unit of the physical 3D object to be printed. In step 406, process 400 may spatially structure an illumination beam of the at least one light source based on the computed property pattern. In step 408, process 400 may project the structured illumination beam onto a material to produce the physical 3D object having the desired physical property. In the process, the property pattern may provide information about a spatial location of the first volumetric unit relative to one or more other volumetric units. Further, the physical 3D object may be a 3D dental object. In one aspect of the process, the material 118 may be selectively treated with a chemical or a defined wavelength of light to activate or deactivate photosensitivity prior to or after printing. Other technical features may be readily apparent to one skilled in the art from the following figures, descriptions, and claims.

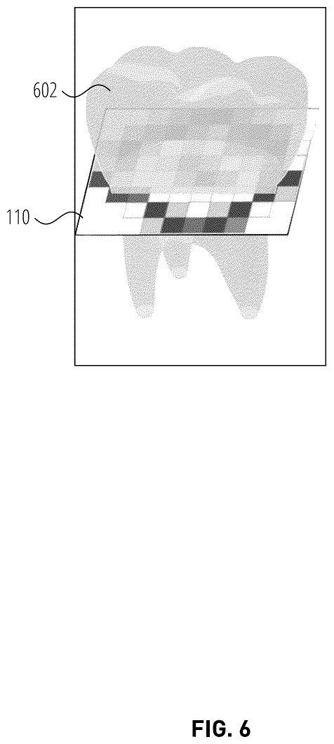

In an aspect herein as shown in FIG. 6, a process utilizing the virtual 3D model 602 and layer 110 comprises varying the light intensity, light color or exposure time per pixel to manipulate the optical appearance of the cured material per pixel/voxel. The process is used to create local variations in translucency, local color or shading of the final printed element in the respective spots which will be a voxel area somewhere in the object later. This may be used to create desired (visible) structures inside the object, e.g. to create some sort of volume shading/stacked color effect which may be applied/limited to the internal and outer areas of the object.

As opposed to anti-aliasing, which may involve modification of light intensity for pixels at the border of a shape to mitigate pixel appearance, the method described herein may be applicable to both internal and external areas of an object to be printed. The method may comprise modifying the curing light intensity (via brightness or duration of exposure) or light color (multi-color display, non-monochrome) not necessarily for the amount of curing material in a pixel/voxel, but to modify it's shading, color or translucency. Furthermore, this is not limited to the outer surface but can be used inside as well to generate colored structures inside the object. Of course those inner effects may only be visible from the outside if the material has some kind of translucency (which is given in case of dental objects/materials to a certain degree). Otherwise, to achieve an inner color variation inside a dental restoration, dental technicians may typically layer/stack varying colors manually on top of each other using a brush and e.g. fluid ceramic colored materials.

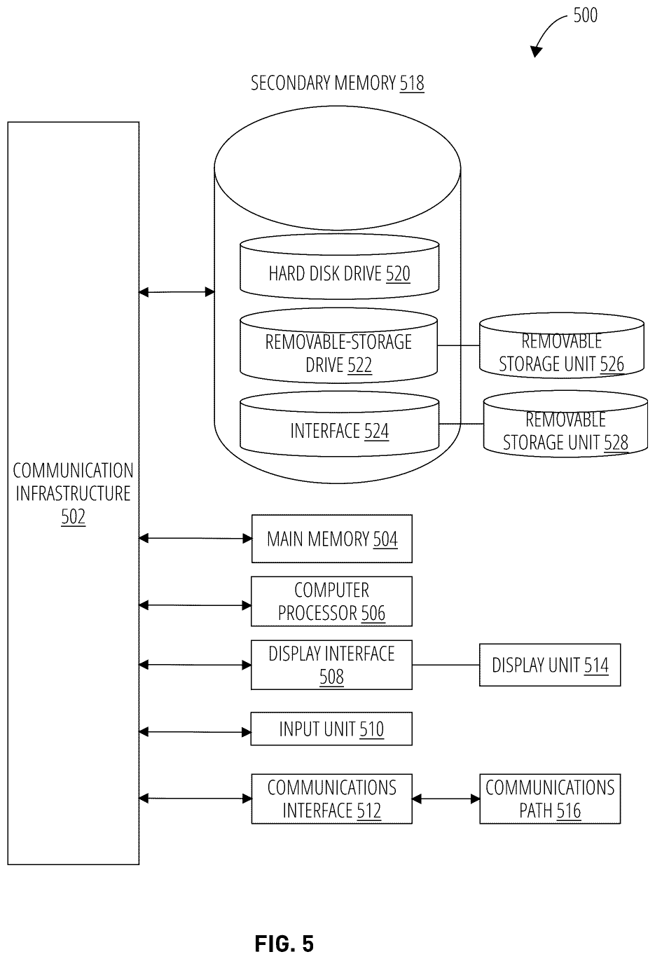

Having described the 3D printing systems and processes, reference will now be made to FIG. 5, which shows a block diagram of a computer system 500 that may be employed in accordance with at least some of the illustrative embodiments herein. Although various embodiments may be described herein in terms of this exemplary computer system 500, after reading this description, it may become apparent to a person skilled in the relevant art(s) how to implement the disclosure using other computer systems and/or architectures.

In one example embodiment herein, at least some components of the 3D printing system may form or be included in the computer system 500 of FIG. 5. For example, the computer processor 506 may form a part of or be the control unit 114 of FIG. 1. The computer system 500 includes at least one computer processor 506. The computer processor 506 may include, for example, a central processing unit (CPU), a multiple processing unit, an application-specific integrated circuit (“ASIC”), a field programmable gate array (“FPGA”), or the like. The computer processor 506 may be connected to a communication infrastructure 502 (e.g., a communications bus, a cross-over bar device, a network). In an illustrative embodiment herein, the computer processor 506 includes a CPU that that controls the 3D printing process, including operating the driving unit 112, moving the platform 120 after a layer is printed, operating the light sources, pattern projector and beam translation module to emit light beams with defined properties, that correspond to cross-sections of the 3D object to me printed.

The display interface 508 (or other output interface) may forward text, video graphics, and other data from the communication infrastructure 502 (or from a frame buffer (not shown)) for display on display unit 514. For example, the display interface 508 may include a video card with a graphics processing unit or may provide an operator with an interface for controlling the system.

The computer system 500 may also include an input unit 510 that may be used, along with the display unit 514 by an operator of the computer system 500 to send information to the computer processor 506. The input unit 510 may include a keyboard and/or touchscreen monitor. In one example, the display unit 514, the input unit 510, and the computer processor 506 may collectively form a user interface.

One or more steps of printing a dental object by controlled local modification of volumetric physical properties may be stored on a non-transitory storage device in the form of computer-readable program instructions. To execute a procedure, the computer processor 506 loads the appropriate instructions, as stored on storage device, into memory and then executes the loaded instructions.

The computer system 500 may further comprise a main memory 504, which may be a random-access memory (“RAM”), and also may include a secondary memory 518. The secondary memory 518 may include, for example, a hard disk drive 520 and/or a removable-storage drive 522 (e.g., a floppy disk drive, a magnetic tape drive, an optical disk drive, a flash memory drive, and the like). The removable-storage drive 522 reads from and/or writes to a removable storage unit 526 in a well-known manner. The removable storage unit 526 may be, for example, a floppy disk, a magnetic tape, an optical disk, a flash memory device, and the like, which may be written to and read from by the removable-storage drive 522. The removable storage unit 526 may include a non-transitory computer-readable storage medium storing computer-executable software instructions and/or data.

In further illustrative embodiments, the secondary memory 518 may include other computer-readable media storing computer-executable programs or other instructions to be loaded into the computer system 500. Such devices may include removable storage unit 528 and an interface 524 (e.g., a program cartridge and a cartridge interface); a removable memory chip (e.g., an erasable programmable read-only memory (“EPROM”) or a programmable read-only memory (“PROM”)) and an associated memory socket; and other removable storage units 528 and interfaces 524 that allow software and data to be transferred from the removable storage unit 528 to other parts of the computer system 500.

The computer system 500 may also include a communications interface 512 that enables software and data to be transferred between the computer system 500 and external devices. Such an interface may include a modem, a network interface (e.g., an Ethernet card or an IEEE 802.11 wireless LAN interface), a communications port (e.g., a Universal Serial Bus (“USB”) port or a FireWire® port), a Personal Computer Memory Card International Association (“PCMCIA”) interface, Bluetooth®, and the like. Software and data transferred via the communications interface 512 may be in the form of signals, which may be electronic, electromagnetic, optical or another type of signal that may be capable of being transmitted and/or received by the communications interface 512. Signals may be provided to the communications interface 512 via a communications path 516 (e.g., a channel). The communications path 516 carries signals and may be implemented using wire or cable, fiber optics, a telephone line, a cellular link, a radiofrequency (“RF”) link, or the like. The communications interface 512 may be used to transfer software or data or other information between the computer system 500 and a remote server or cloud-based storage (not shown).

One or more computer programs or computer control logic may be stored in the main memory 504 and/or the secondary memory 518. The computer programs may also be received via the communications interface 512. The computer programs include computer-executable instructions which, when executed by the computer processor 506, cause the computer system 500 to perform the methods as described hereinafter. Accordingly, the computer programs may control the computer system 500 and other components of the 3D printing system.

In another embodiment, the software may be stored in a non-transitory computer-readable storage medium and loaded into the main memory 504 and/or the secondary memory 518 using the removable-storage drive 522, hard disk drive 520, and/or the communications interface 512. Control logic (software), when executed by the computer processor 506, causes the computer system 500, and more generally the 3D printing system, to perform some or all of the methods described herein.

What is claimed is:

1. A method comprising:
providing at least one light source;
computing, by a beam translation module, a property pattern for a layer of a virtual 3D model, the property pattern including at least a first light property configured to produce a desired physical property of a first volumetric unit of a physical 3D object to be printed;
structuring an illumination beam of the at least one light source based on the computed property pattern; and
projecting the structured illumination beam onto a material to produce the physical 3D object having said desired physical property,
wherein the material is a photosensitive resin or a photosensitive extruded material, and
wherein the first volumetric unit is not confined to edges of the layer being 3D printed.

2. The method of claim 1, further comprising configuring the property pattern as a pixel pattern and wherein the pixel pattern includes at least a first 2D pixel configured to represent the first light property.

3. The method of claim 2, further comprising:
computing, by the beam translation module, a plurality of pixels of the pixel pattern to achieve a plurality of corresponding physical properties for a plurality of virtual 3D voxels of the layer being 3D printed.

4. The method of claim 1, wherein the property pattern is a light color pattern, a light intensity pattern or a light exposure length per pixel pattern.

5. The method of claim 1, further configuring the property pattern as a number pattern, a letter patterns, a keywords pattern and/or a coordinates pattern.

6. The method of claim 1, further configuring the property pattern to provide information about a spatial location of the first volumetric unit relative to one or more other volumetric units.

7. The method of claim 1, wherein the physical property is a property selected from the list consisting of a color of at least a portion the physical 3D object, a translucency of at least a portion of the physical 3D object and shading of at least a portion of the physical 3D object.

8. The method of claim 7, wherein prior to completion of a curing process of the material, a value of the physical property corresponding to the first volumetric unit is based on a value of the first light property of the property pattern, wherein said first light property represents the property of light to be applied to the first volumetric unit.

9. The method of claim 1, wherein the physical 3D object is a 3D dental object.

10. The method of claim 1, wherein the physical 3D object is produced by SLA (stereolithography) 3D printing.

11. The method of claim 1, wherein the physical 3D object is produced by FDM (fused deposition modeling) 3D printing.

12. The method of claim 1, wherein the material is selectively treated with a chemical or a defined wavelength of light to activate or deactivate photosensitivity prior to or after printing.

13. The method of claim 3, wherein the plurality of pixels are configured to achieve a desired effect for a subsection of the physical 3D object.

14. The method of claim 3, wherein the plurality of pixels are configured to achieve a desired effect for a whole of the physical 3D object.

15. The method of claim 1, wherein the illumination beam is structured spatially by a DMD (digital micromirror device) prior to projecting the structured illumination beam onto the material.

16. The method of claim 1, wherein each layer of the physical 3D object is printed by tracing a geometry of the layer via movement of a scanning mirror.

17. A system comprising at least one light source, a beam translation module, and a processor configured to:
compute, by the beam translation module, a property pattern for a layer of a virtual 3D model, the property pattern including at least a first light property configured to produce a desired physical property of a first volumetric unit of a physical 3D object to be printed;
structure an illumination beam of the light source based on the computed property pattern; and
project the structured illumination beam onto a material to produce the physical 3D object having said desired physical property,
wherein the material is a photosensitive resin or a photosensitive extruded material, and wherein the first volumetric unit is not confined to edges of the layer being 3D printed.

18. A non-transitory computer-readable storage medium storing a program which, when executed by a computer system, causes the computer system to perform a procedure comprising the steps of:
computing, by a beam translation module, a property pattern for a layer of a virtual 3D model, the property pattern including at least a first light property configured to produce a desired physical property of a first volumetric unit of a physical 3D object to be printed;
structuring an illumination beam of a light source based on the computed property pattern; and
projecting the structured illumination beam onto a material to produce the physical 3D object having said desired physical property,
wherein the material is a photosensitive resin or a photosensitive extruded material, and wherein the first volumetric unit is not confined to edges of the layer being 3D printed.
